(19) United States
(12) Patent Application Publication
(10) Pub. No.: US 2001/0003815 A1
(43) Pub. Date: Jun. 14, 2001

(54) Internet-based information retrieval service system

(76) Inventor: Toshiaki Nakano, Tokyo (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/731,706

(22) Filed: Dec. 8, 2000

(30) Foreign Application Priority Data
Dec. 8, 1999 (JP) P. HEI.11-348783

(51) Int. Cl. G06F 7/00

(52) U.S. Cl. 707/1

(57) ABSTRACT

An information retrieval site S1 connected to the Internet has a retrieval server S1a and a retrieval database S1b. The retrieval server S1a of this information retrieval site S1 fetches data representing the details of services respectively provided by a plurality of hotel reservation sites S2, S3, . . . therefrom and stores the data in the retrieval database S1b. Moreover, the server S1a retrieves data corresponding to information-retrieval input information, which is inputted from an information terminal T, from the retrieval database S1b according to the inputted information. Then, the server S1a causes a monitor of the information terminal T to display data read by this retrieval.

### BACKGROUND OF THE INVENTION

The present invention relates to an information retrieval service system for offering users a service for retrieving desired various kinds of information through the Internet.

In recent years, as an information terminal, for example, a microcomputer, comes into wide use, an Internet-based information providing service has rapidly been expanded.

Further, there are many kinds of services of providing living information on, for instance, hotel reservation, group tour application, concert ticket purchase/reservation, airline ticket purchase/reservation, and reserved seat ticket purchase/reservation.

For instance, the hotel reservation information providing service is provided at a hotel reservation site that is operated by each agent. When a user utilizes the service, he accesses the hotel reservation site through the Internet by specifying the URL (Uniform Resource Locator) of the hotel reservation site, which offers the service to be utilized, at an information terminal. Then, he enters desired conditions, such as a region name, a hotel name, and a lodging charge, on a displayed reservation page, and makes a search for the hotel that meets the entered conditions. Thereafter, he makes a reservation.

Other information providing services are utilized by similar methods.

Incidentally, even when the information providing sites offer the same information providing service, the details of the service may differ with agents that operate the information providing sites, respectively. A user sometimes wishes to utilize the service after he makes comparisons among the details of the services respectively provided by a plurality of information providing sites.

For example, regarding the hotel reservation service, the lodging charge by the same hotel may vary with agents that operate the hotel reservation sites for providing this service.

However, generally, it is usual that the information providing sites each offering the information providing service are not linked to one another. When a user utilizes the service after comparisons among the details of the services respectively provided by a plurality of information providing sites, he needs to individually access the sites and to cause a monitor to sequentially display information providing pages corresponding to the accessed site.

It is, thus, very troublesome to make comparisons among the details of the services respectively offered by a plurality of information providing sites.

### SUMMARY OF THE INVENTION

The present invention is accomplished to solve the problems in a conventional Internet-based information providing service system.

Accordingly, an object of the invention is to provide an Internet-based information providing service system that enables a user's search and easy comparison of information providing services offered by a plurality of information providing sites.

According to the present invention, there is provided a first Internet-based information retrieval service system, which comprises an information retrieval site connected to the Internet and having a retrieval server and a retrieval database. In this system, the retrieval server of the information retrieval site is operative to fetch data representing the details of services respectively provided by a plurality of information providing sites therefrom and to store the data in the retrieval database. Moreover, the server is operative to retrieve data corresponding to information-retrieval input information, which is inputted from an information terminal, from the retrieval database according to the inputted information, and to then cause the monitor of the information terminal to display data read by the retrieval.

According to the first information retrieval service system, a user utilizes an information retrieval service by using the information terminal serving as a user terminal to thereby access the information retrieval site through the Internet.

Further, before utilized by a user, the retrieval server of the information retrieval site preliminarily fetches data representing the details of the service offered by each of the information providing sites, which are operated by agents offering, for example, hotel reservation services. That is, the retrieval server preliminarily fetches data representing a lodging charge by a hotel, the service of reservation of which is offered by the information providing site. Then, the server preliminarily stores the fetched data in the retrieval database. When a user enters input information for information retrieval, for instance, information indicating a hotel, the reservation of which is to be made, into the accessed information terminal, the server retrieves and reads data from the retrieval database. Subsequently, the server causes the monitor of the information terminal to display the read data.

Consequently, among the data stored in the retrieval database, all data corresponding to the input information, for example, all data representing the lodging charge in the case of each of the information providing sites, which offer the service of reservation of the specified hotel, is displayed on the monitor of the information terminal.

Therefore, according to the first information providing service system of the present invention, among data representing the details of services offered by a plurality of information providing sites, almost all service data corresponding to input information needed for performing information retrieval is displayed on the monitor of the information terminal by using this system. Thus, a user can compare the displayed details of the services and finally determine the information providing site to be utilized. This eliminates the necessity for access to all the information providing sites, which is needed by the conventional system. Consequently, users can easily compare the details of the services.

To achieve the foregoing object, according to the present invention, there is provided a second Internet-based information retrieval system, which has the constituent elements of the first Internet-based information retrieval system. Additionally, in the second Internet-based information retrieval system, the retrieval server fetches the data representing the details of services, which are respectively provided by the plurality of information providing sites, therefrom by periodically accessing the plurality of information providing sites.

According to the second Internet-based information retrieval service system of the present invention, the retrieval server of the information retrieval site periodically accesses a plurality of information providing sites at predetermined time intervals. Thus, data representing the details of the service offered by each of the information providing site is stored in the retrieval database. Consequently, the latest service data can be always displayed on the monitor of the information terminal.

To achieve the foregoing object, according to the present invention, there is provided a third Internet-based information retrieval service system, which has the constituent elements of the first Internet-based information retrieval service system. In the third Internet-based information retrieval service system, a hyperlink indicating an Internet address of the information providing site providing the data is embedded in a data image that is displayed on the monitor of the information terminal by the retrieval performed by the retrieval server.

According to the third Internet-based information retrieval service system, when a user compares the data representing the details of the services offered by the information providing sites, which are displayed on the monitor of the information terminal, and finally determines the information providing site offering the service to be utilized, a WWW page of the information providing site having provided the data can easily be opened by utilizing the hyperlink embedded in the data image corresponding to the determined information providing site.

To achieve the foregoing object, according to the present invention, there is provided a fourth Internet-based information retrieval service system, which has the constituent elements of the first Internet-based information retrieval service system. Additionally, in the fourth Internet-based information retrieval service system, the information retrieval site has a user registration database for storing a profile of a preliminarily registered user. Moreover, the retrieval server retrieves the data, which corresponds to the information-retrieval input information, according to the profile of a user, which is read from the user registration database.

In the case of the fourth Internet-based information retrieval service system, when a user registered in the information retrieval site accesses the retrieval server, the retrieval server reads the profile of the user from the user registration database according to a user registration number inputted to the information terminal.

Further, when data corresponding to the information-retrieval input information is retrieved from the retrieval database, the retrieval server reads only or preferentially data corresponding to the read profile of the user according thereto.

Therefore, according to the fourth Internet-based information retrieval service system of the present invention, when a user utilizes this information retrieval service, desired data is preferentially displayed by preliminarily registering desired conditions in the information retrieval site. This facilitates the selection of the information providing site that offers the service to be utilized by the user.

### BRIEF DESCRIPTION OF THE DRAWINGS

FIG. 1 is a diagram illustrating the system configuration of an embodiment of the present invention.

FIGS. 2A to 2C are diagrams illustrating WWW pages displayed on a monitor of an information terminal of this embodiment of the present invention.

FIG. 3 is a diagram illustrating the system configuration of another embodiment of the present invention.

### DETAILED DESCRIPTION OF THE PREFERRED EMBODIMENTS

Hereinafter, the most preferable embodiment of the present invention will be described by referring to the accompanying drawings.

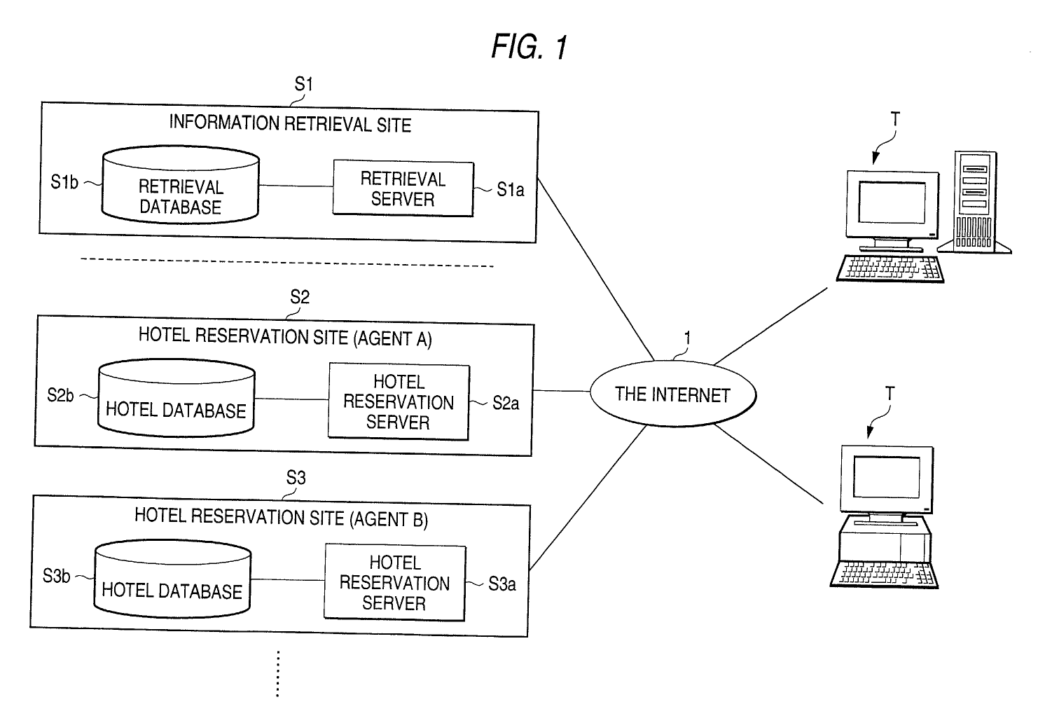

FIG. 1 is a diagram illustrating the system configuration of an embodiment in the case that the information retrieval system of the present invention is applied to the retrieval of a hotel reservation service provided by an agent, such as a travel agent.

In the system of FIG. 1, the information retrieval site S1 offers users an information retrieval service of retrieving information on hotel reservation. The information retrieval site S1 has the retrieval server S1a and the retrieval database S1b, in which hotel data fetched from a hotel reservation site (to be described later) is stored, and is connected to the Internet I.

Further, the hotel reservation sites S2, S3, . . . are existing sites operated by agents so as to provide hotel reservation services. Each of the hotel reservation sites S2, S3, . . . has a corresponding one of hotel reservation servers S2a, S3a, . . . , and a corresponding one of hotel databases S2b, S3b, . . . , in each of which hotel data representing accommodations, lodging charges, and vacancy conditions is stored, and is connected to the Internet I.

Furthermore, users can utilize the information retrieval service, which is offered by the information retrieval site S1, by connecting the information terminal T, which serves as a user terminal, to the Internet through a public telephone network (not shown) and an access server (not shown) and by using an application program called a WWW browser to thereby access the information retrieval site S1.

The retrieval server S1a of the information retrieval site S1 is programmed in such a manner as to access periodically accesses each of the hotel reservation sites S2, S3, . . . through the Internet I, and to then fetch hotel data stored in the hotel databases S2b, S3b, . . . , and to subsequently store the fetched data in the retrieval database S1b. The server S1a is also programmed in such a way as to transmit HTML data, which is used for displaying a WWW page so as to search for a hotel, to the information terminal T when accessed by this information terminal T.

Further, when a hotel is specified on the WWW page displayed on the monitor of the information terminal T, the retrieval server S1a retrieves and reads all the hotel data on the specified hotel from the hotel data fetched from the hotel reservation sites S2, S3, . . . , which is stored in the retrieval database S1b. Thereafter, the server S1a transmits the read data to the information terminal T and causes the monitor to display the transmitted data.

Thus, all the details of the services provided by the hotel reservation sites correspondingly to the specified hotel are displayed on the monitor of the information terminal T. Consequently, a user can determine the hotel reservation site, at which he performs reservation of the hotel, by comparing the details of the services provided the hotel reservation sites S2, S3, . . . and displayed on the monitor.

Next, a method of retrieving hotel information by using the information retrieval system is more concretely described hereinbelow.

In the case that a user utilizes this information retrieval system, he accesses the information retrieval site S1 by specifying the URL thereof, and causes the motor to display a WWW page. Then, the hotel, whose hotel data is to be retrieved, is specified on this WWW page.

The specifying of the hotel on this WWW page is performed by a method of directly entering the name of the hotel by the user, and alternatively, by a method in which the retrieval server S1a retrieves from the retrieval database S1b hotels located in a region specified by the user by entering a region name (for instance, an address or a station name) and displays a list of the retrieved hotels on a WWW page, and then the user selects a hotel from the displayed list of the hotels.

Alternatively, the following method may be employed to specify the hotel. That is, according to the region name (for instance, the address and the station name) specified by the user, the retrieval server S1a reads a map image of the specified region from a map database site (not shown) and displays the map image on a WWW page. Moreover, the server S1a reads landmark data corresponding to hotels located in the specified region from landmark data stored in a landmark database (not shown), which is provided in the information retrieval site S1, together with coordinate data (namely, latitude data and longitude data). Then, the server S1a causes the monitor to display the landmark data in the map image on the WWW page. Subsequently, the user selects a landmark indicating a hotel in this map image.

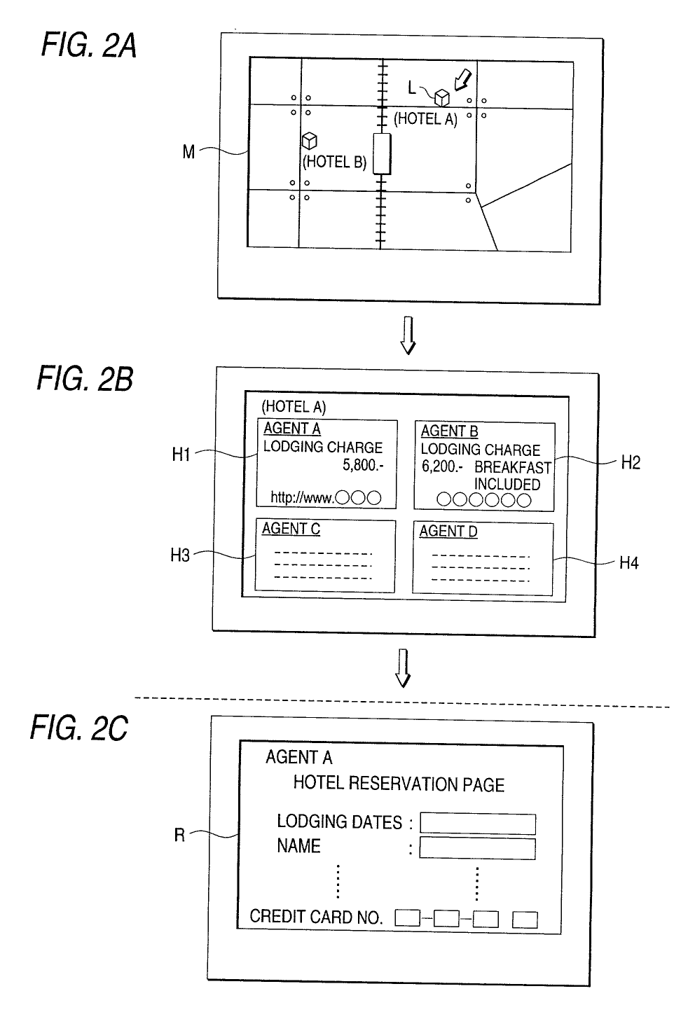

When the hotel is thus specified on the WWW page displayed on the monitor of the information terminal T, the retrieval server S1a of the information retrieval site S1 retrieves and reads all the hotel data on the specified hotel from the hotel data fetched from the hotel reservation sites S2, S3, . . . , which is stored in the retrieval database S1b. Thereafter, the server S1a transmits the read data to the information terminal T and causes the monitor to display the transmitted data on a WWW page, as illustrated in FIGS. 2A to 2C.

Incidentally, FIGS. 2A to 2C illustrate an example of the case that the hotel is specified by selecting a corresponding landmark in a map image displayed on a WWW page. When a user selects a desired landmark L indicating the location of a hotel A in a map image M displayed on a WWW page by specifying a region as illustrated in FIG. 2A, hotel data S2, S3, . . . respectively corresponding to the hotel reservation sites are read from the retrieval database S1b of the information retrieval site S1 and displayed in respective indicating fields H1, H2, . . . opened by splitting the screen.

The hotel data indicating fields H1, H2, . . . indicate the details of the services provided by agents A, B, . . . that operate the hotel reservation sites S2, S3, . . . , respectively. That is, these fields indicate the details of the service offered by the agent by which a room of a hotel is reserved. For example, these fields indicate information on lodging charges, meals included therein, check-in time, and check-out time. Thus, users can select one of the agents by comparing the details of the services displayed in the hotel data indicating fields.

When a user thus determines the agent, by which the reservation of a hotel is performed, he accesses the hotel reservation site S2, S3, or . . . of this agent (the agent A in the case of this example) from the information terminal T and enters necessary data representing, for instance, his name and address and the credit card number of a credit card used for payment in a hotel reservation page R corresponding to this agent.

At that time, users can easily access the hotel reservation sites S2, S3, . . . in the case that the URLs of these sites are embedded as hyperlinks in the hotel data indicating fields H1, H2, . . . displayed on the WWW page corresponding to the information retrieval site S1.

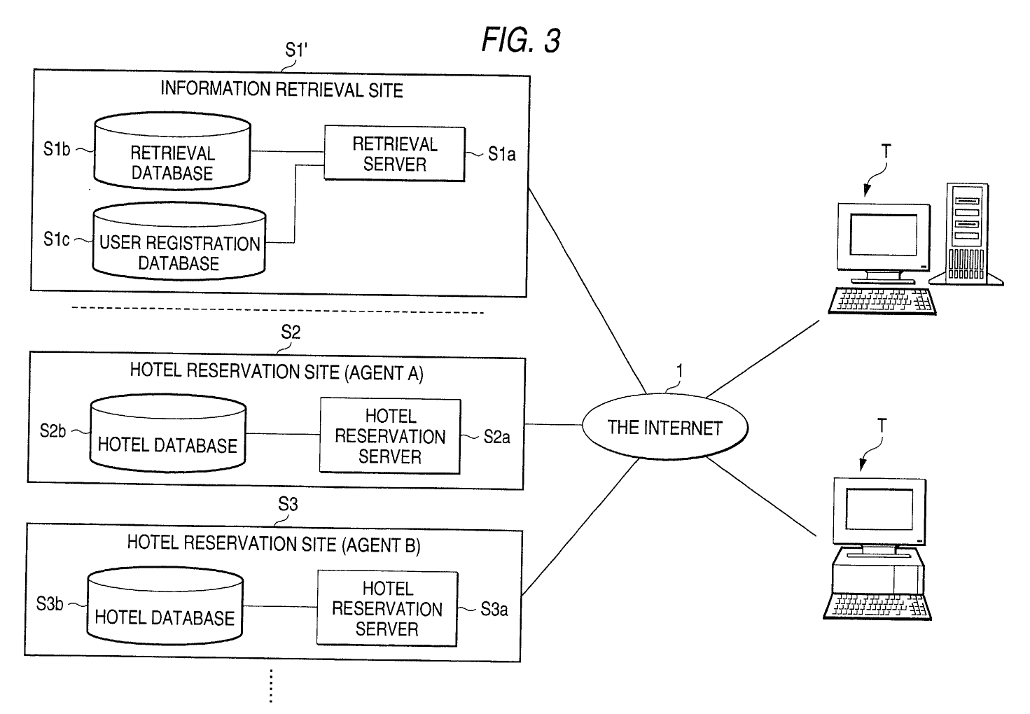

FIG. 3 is a diagram illustrating the system configuration of an information retrieval service system that is another embodiment of the present invention.

The information retrieval service system according to this embodiment has a user registration database S1c, in which data representing the profiles of preliminarily registered users are stored, in an information retrieval site S1′ in addition to the constituent elements of the information retrieval service system shown in FIG. 1. That is, the remaining constituent elements of the information retrieval service system according to this embodiment are similar to the corresponding constituent elements of the information retrieval service system illustrated in FIG. 1.

In the case of the information retrieval service system according to this embodiment, when a user registered in an information retrieval site S1′ accesses thereto, the retrieval server S1a of the information retrieval site S1′ reads data representing the profile of the user from the user registration database S1c according to a user registration number inputted to the information terminal T.

Further, when a hotel specified by the user is retrieved from the retrieval database S1b, the retrieval server S1a reads only or preferentially data corresponding to the read profile of the user from the hotel data corresponding to the hotel reservation sites S2, S3, . . . according thereto and causes the monitor to display the read data.

For example, in the case that the user likes a hotel, which charges a lodging fee including a breakfast or two meals and throws a morning paper in free of charge, the hotel data on hotels meeting such conditions is preferentially read from among the hotel data corresponding to the hotel reservation sites S2, S3, . . . , respectively.

According to the information retrieval service system of this embodiment, in the case that a user registers desired conditions in the information retrieval site S1, the hotel data meeting the desired conditions is preferentially displayed when he utilizes the information retrieval service provided by this system. Thus, the user can more easily select the hotel reservation site, through which the reservation of a hotel is performed.

Incidentally, in the foregoing description of each of the embodiments, the case of applying the information retrieval service system of the present invention to that for hotel reservation has been described. However, in addition to the information retrieval service for hotel reservation, the information retrieval service system of the present invention can be applied to various kinds of information providing services offered by competitive information providing sites, for instance, to the case that when a user books a ticket for a concert, he applies for a ticket for a reserved seat corresponding to a desired position by specifying a concert name and comparing the positions of reserved seats sold by agents for the concert, and that when a user books an airline ticket, he applies for a ticket for an airplane, which operates within a desired period of time, by specifying departure and arrival airports and comparing the departures and arrival times of airplanes of airplane companies.

What is claimed is:

1. An information retrieval service system comprising:
an information retrieval site connected to the Internet including:
a retrieval server, and
a retrieval database, wherein
said retrieval server of said information retrieval site is operative to fetch data representing details of services respectively provided by a plurality of information providing sites therefrom so as to store the data in said retrieval database, and is operative to retrieve data corresponding to information-retrieval input information, which is inputted from an information terminal, from said retrieval database according to the inputted information so as to cause a monitor of said information terminal to display data read by the retrieval.

2. The information retrieval service system according to claim 1, wherein
said retrieval server fetches data representing details of services, which are respectively provided by the plurality of information providing sites, therefrom by periodically accessing the plurality of information providing sites.

3. The information retrieval service system according to claim 1, wherein
a hyperlink indicating an Internet address of the information providing site providing the data is embedded in a data image that is displayed on said monitor of said information terminal by the retrieval performed by said retrieval server.

4. The information retrieval service system according to claim 1, wherein
said information retrieval site includes a user registration database for storing a profile of a preliminarily registered user, and
said retrieval server retrieves the data, which corresponds to the information-retrieval input information, according to a profile of a user, which is read from said user registration database.
